(19) United States
(12) Patent Application Publication
(10) Pub. No.: US 2007/0136181 A1
(43) Pub. Date: Jun. 14, 2007

(54) METHOD FOR ESTABLISHING A VALUE FOR A NON-MARKET SECURITY

(75) Inventor: Jonathan Miller, Haverford, PA (US)

Correspondence Address: SYNNESTVEDT & LECHNER, LLP, 1101 MARKET STREET, 26TH FLOOR, PHILADELPHIA, PA, 19107-2950, US

(73) Assignee: Paramount Financial Communications, Inc., Ardmore, PA (US)

(21) Appl. No.: 11/539,359

(22) Filed: Oct. 6, 2006

(51) Int. Cl. G06Q 40/00

(52) U.S. Cl. 705/37

(57) ABSTRACT

Provided is a method and apparatus for establishing a value for a non-marketable security in which an electronic forum is provided for trading the securities and in which the value of the security is established by matches between sell offers and buy offers.

### BACKGROUND

(1) Field of Invention

The invention relates to a method for establishing a value of a non-marketable security, such as an employee stock option, wherein the non-marketable security is traded in an electronic forum.

(2) Description of Related Art

Non-marketable securities are those which cannot be readily bought or sold publicly. Thus, unlike freely tradable shares of stock or bonds, there are no open markets for non-marketable securities and, therefore, no market price established for such securities. The accurate valuation of non-marketable securities such as, for example, employee stock options, is important for at least three reasons: (1) individuals who have a substantial portion of their net worth represented by non-marketable securities can improve their tax planning and risk-diversification strategies; (2) firms who utilize employee stock options can more accurately report labor-related costs; (3) firms can design more efficient compensation packages that provide the desired retention and incentive benefits; and (4) firms can more easily and inexpensively determine the expense factor of their securities benefits plans, now required of publicly held companies in reports to the Securities and Exchange Commission by FAS 123R standards. The lack of market value for a non-marketable security may also prevent its holder from receiving the market price for the security. For example, the value an employee receives from exercising an employee stock option is the option's intrinsic value (i.e., the stock price minus the option's strike price) instead of the market price that would equal the sum of the option's intrinsic value and its time value (i.e., the value associated with the possibility of future stock prices increases). Moreover, since the employee generally cannot hedge the risk of the option, employees may tend to place a lower value on employee stock options and tend to exercise them earlier than would an outside investor.

Valuation models have been developed that attempt to determine the market value of a stock option. For example, the Black-Scholes model, which was originally designed for valuing exchange-traded options, can be applied to valuing employee stock options. However, some empirical data suggests that the Black-Scholes model can overstate the value of employee stock options by more than 50 percent. See, for example, S. Huddart, et al., Employee Stock Option Exercise: An Empirical Analysis, The Journal of Accounting and Economics (1996). Moreover, as pointed out by numerous authors (Huddart, S., “Employee Stock Options”, Journal of Accounting and Economics, Vol. 18, pages 207-231(1994); Kulatilaka, N. and Marcus, A. J., Valuing Employee Stock Options, Financial Analysts Journal, pages 46-56 (November-December 1994); Rubinstein, M., On the Accounting Valuation of Employee Stock Options, Journal of Derivatives, (Fall 1995)), employee stock options are quite different from exchange-traded options, and these differences cause valuations based on the Black-Scholes model to be overstated.

In an attempt to overcome the limitations of the Black-Scholes model, Huddart, Kulatilaka et al., and Rubinstein, developed binomial tree-based models, which assume that employees make exercise decisions to maximize the expected utility of terminal wealth. The models developed by them are an improvement over the Black-Scholes model in that they address the effect of risk aversion and wealth effects on employee stock option value. However, with the exception of the Rubinstein model, they do not reflect the effect of other factors affecting employee stock option value (e.g., vesting or forfeiture) nor do they address how to calibrate their models to observed measures of exercise and forfeiture behavior. Although Rubinstein's model does reflect the effect of vesting and forfeiture, it too fails to consider other factors affecting value and does not provide a means of calibrating the model to observed behavior.

In Carpenter, J. N., The Exercise and Valuation of Executive Stock Options, Journal of Financial Economics, Vol. 48, 1998, pages 127-158 (1998), Carpenter develops a binomial model in which exercise decisions are based on the maximization of terminal wealth. The model reflects vesting and forfeiture and can be calibrated to observed measures of exercise and forfeiture. The model is calibrated by fitting a curve through the early exercise boundary based on a model with annual time steps, and it is shown that a simple extension of the ordinary American option-pricing model that incorporates random, exogenous exercise and forfeiture behavior can predict exercise behavior as well as a more elaborate utility maximization model. However, this conclusion may be related to the particular parameters used in this analysis. A risk aversion parameter of 2.0 is used in the analysis, which is usually believed to be an average level of risk aversion. It has been shown that, at high levels of risk aversion, ordinary American option-pricing models can give incorrect results (Kulatilaka and Marcus (1994)). This occurs because at high levels of risk aversion, employee stock option values can be inversely related to volatility. The value of exchange-traded American options increase with increases in volatility.

All of these attempts to value employee stock options are from the perspective of cost to the firm as opposed to the value of the employee stock option to the employee. Lambert et al. (1991) were the first to value employee stock options from the perspective of the employee stock option holder (see, Lambert, R. A.; Larcker, D. F.; and Verrecchia, R. E., Portfolio Considerations in Valuing Executive Compensation Journal of Accounting Research, Vol. 29(1), pages 129-149 (Spring 1991)). A certainty equivalent framework is used to determine the value of a European option to the employee stock option holder, and it shows that the employee stock option is worth substantially less to a risk-averse and poorly diversified employee than it costs the firm.

Hall and Murphy present a model to determine the value of employee stock options to employees in various applications (see Hall, B. J. and Murphy, K. J., Optimal Exercise Prices for Risk Averse Executives, American Economic Review, (December 2000)(“Hall and Murphy”). A drawback with this model is that for certain “deep in the money” employee stock options, the value produced by this model can be less than the option's intrinsic value at the grant date. To cure this deficiency, Hall and Murphy extended the Lambert model to reflect the possibility of early exercise. However, their model does not address the other features of employee stock options and does not provide a means for calibrating the model to observed behavior.

To address non-traditional employee stock option features, such as repriceability (which allows the strike price to be reset if the option is too far “under water”), performance vestment (which vests only if the underlying stock price exceeds a prescribed level), indexing (which allows the strike price to vary according an index), and purchase feature (which requires the employee to pay a portion of the strike price at the grant date and the remainder of the strike price when the option is exercised), Johnson and Tian provide formulas for valuing most of the non-traditional types of employee stock options, including indexed options, performance vested options, repriceable options and purchased options. (See, Johnson, S. A. and Tian, Y. S., The Value and Incentive Effects of Nontraditional Executive Stock Option Plans, Journal of Financial Economics, Vol. 57, 2000, pages 3-34, (2000))(“Johnson and Tian”). All of their models assume that the employee stock options are European (i.e., can only be exercised at the options' expiration date). Also, their models do not address the other features of employee stock options, such as vesting and forfeiture, do not address model calibration, and value employee stock options only from the perspective of the company.

Various other methods have been developed to estimate the value of employee stock options. For example, US 2005/0114242 to Gray and US 2005/0010518 to Friedman disclose the use of an option value formula that can be used to determine whether to convert non-transferable employee stock options into transferable options. US 2004/0267656 to Friedman discloses a method of determining the value of an employee stock option by averaging the price obtained from various theoretical pricing models with the average traded stock price over a period of time.

Methods have also been developed to electronically manage employee stock options. For example, U.S. Pat. No. 5,671,363 to Cristofich, U.S. Pat. No. 6,173,270 to Cristofich, and U.S. Pat. No. 6,269,346 to Cristofich are directed to systems for managing the purchase price, grant dates, and vesting of employee stock options. Others have developed methods for maximizing the value of employee stock options via hedging, risk allocation, tax minimization, and the like. See, for example, US 2002/0194136 to Sullivan (disclosing an employee stock option system for hedging, particularly to minimize taxes); and US 2004/0128221 to Pandher (describing means for evaluating various severance risks to arrive at a risk-neutral model value).

The present invention overcomes these and other problems and deficiencies associated with valuation methods of the prior art by using an actual market to estimate the value of a non-marketable security.

### SUMMARY OF THE INVENTION

Applicants have discovered an effective method for accurately estimating a value of a non-marketable security directly from market-driven information. More specifically, the present invention is directed to a method and apparatus wherein offers to sell a non-marketable security and offers to buy the non-marketable security are posted on a forum, and wherein the value of the security is determined from a match of sell and buy offers. This method advantageously emulates the dynamics of an open market, thereby providing a more accurate estimate of the value of a non-marketable security than is presently available via theoretical mathematical models.

Thus, according to an aspect of the present invention, there is provided a method for establishing a value for a non-marketable security comprising the step of providing an electronic forum for trading non-marketable securities wherein the forum is adapted to receive at least one sell offer and at least one buy offer for the security, to match a sell offer with a buy offer, and to establish a value of the security from the match.

According to another aspect of the invention, there is provided a method for establishing a value for a non-marketable security, comprising the step of posting a sell offer or a buy offer for the security onto an electronic forum, wherein the forum is adapted to receive at least one sell offer and at least one buy offer, to match a sell offer to a buy offer, and to establish a value of the security from the match.

According to yet another aspect of the invention, there is provided a method for establishing a value for a non-marketable security, comprising the step of exchanging an asset of a value equivalent to a forum-derived value for the security, wherein the forum-derived value is determined by matching a sell offer with a buy offer in an electronic forum for trading non-marketable securities wherein the forum is adapted to receive at least one sell offer and at least one buy offer for the security, to match a sell offer with a buy offer, and to establish a value of the security from the match.

According to another aspect of the invention, there is provided an electronic trading platform for valuing non-marketable securities comprising (a) an electronic database of information regarding non-marketable securities available for sale, offers to sell securities, and offers to buy securities; (b) a system for transferring information from said database to participating vendors and vendees; (c) a system for receiving a vendor's offer to sell a security; (d) a system for receiving a vendee's offer to buy the security; (e) a system for matching the offers; and (f) a system for establishing a value of the security from the match.

### BRIEF DESCRIPTION OF THE DRAWINGS

The invention will be more fully understood and further advantages will become apparent in view of the following drawings wherein:

FIG. 1 is a flow diagram depicting an exemplary method for estimating the value of a non-marketable security in accordance with an embodiment of the present invention.

FIG. 2 shows an embodiment of an electronic trading platform according to the present invention.

### DETAILED DESCRIPTION OF PREFERRED EMBODIMENTS OF THE INVENTION

The present invention is generally directed to a method and an apparatus for establishing a value for a non-marketable security via matching a sell offer to a buy offer. As used herein, the term security is used broadly to include any note, stock, treasury stock, security future, bond, debenture, certificate of interest or participation in any profit-sharing agreement or in any oil, gas, or other mineral royalty or lease, any collateral-trust certificate, preorganization certificate or subscription, share, investment contract, voting-trust certificate, certificate of deposit for a security, any put, call, straddle, option, or privilege on any security, certificate of deposit, or group or index of securities (including any interest therein or based on the value thereof), or any put, call, straddle, option, or privilege relating to foreign currency, or in general, any instrument commonly known as a “security”; or any certificate of interest or participation in, temporary or interim certificate for, receipt for, or warrant or right to subscribe to or purchase, any of the foregoing. “Non-marketable security” extends to all types of securities that cannot be readily bought or sold. Conventionally, non-marketable securities are characterized as having an undetermined or theoretical price estimated from, for example, a valuation formula. Examples of non-marketable securities include, but are not limited to, employee stock options, restricted share plan awards, performance-based securities benefit plan awards, and stock-appreciation rights awards.

The term “value” as used herein means an amount, as of goods, services, or money, considered to be a fair and suitable equivalent for something else.

The term “match” as used herein means to find or produce a counterpart to, and is not limited only to finding two items that correspond exactly. That is, methods of the present invention are preferably adapted to identify a relationship between at least one sell offer and at least one buy offer wherein the price of buy offer is preferably greater than or equal to the price of the sell offer. Other criteria for establishing the market value of a security can also be practiced with the present invention, including, for example, some value between a sell offer and a relatively lower buy offer or some value between a sell offer and a relatively higher buy offer.

In one embodiment, an electronic forum for non-marketable securities is provided wherein the forum is adapted to receive at least one sell offer and at least one buy offer for a non-marketable security, to match a sell offer with a buy offer, and to establish a value of the security from the match.

Fora of the present invention comprise static or dynamic pricing mechanisms which, in turn, define the organization, information exchange process, and trading procedure of the fora. Types of pricing mechanisms that may be practiced in accordance with the present invention include, but are not limited to, exchanges and auctions. As used herein, the term “exchange” means a system for trading securities wherein offers to sell securities and offers to buy securities are made and matched substantially contemporaneously. As used herein, the term “auction” means a system of trading securities wherein one or more winning bidder purchases a security for some bid amount. Examples of preferred types of auctions include, but are not limited to, open-bid, ascending-price auctions (e.g., English auctions); open-bid, descending-price auctions (e.g., Dutch auctions); sealed first-price auction (blind) auctions; sealed second-price auctions (e.g., Vickrey auctions); and double auctions.

For embodiments utilizing an English auction, potential vendees bid openly against one another, with each accepted bid being higher than the previous bid. The auction ends when no participant is willing to bid higher than the highest bid, or when a pre-determined “buy-out” price is reached at which point the highest bidder becomes the buyer at the price set by the high bid. The vendor may set a reserve price and, if the auction fails to elicit a bid at or above the reserve price the vendor may reject the high bid. A variation of the English auction that may be practiced with the present invention is the multi-unit English ascending auction where several identical goods are sold simultaneously to one or more high bidders.

For embodiments utilizing a Dutch auction, the auction begins with a high asking price which is lowered until some participant is willing to accept the auctioneer's price, or a predetermined minimum price is reached. That participant pays the last announced price. This type of auction is convenient when it is important to auction goods quickly, since a sale never requires more than one bid.

For embodiments utilizing a sealed first-price auction (also known as a sealed high-bid auction or a first-price sealed-bid auction (FPSB)), all bidders submit bids so that no bidder knows the bid of any other participant. Once all of the bids are received, the bids are unsealed and the highest bidder wins the auction at the bid they submitted.

For embodiments utilizing a sealed second-price auction, all bidders submit bids so that no bidder knows the bid of any other participant. In this regard, the sealed second-price auction is similar to the sealed first-price auction. However, in the sealed second-price auction the highest bidder wins the auction but pays the second highest bid rather than their own.

If more than one identical item is to be sold, there are two possible generalizations of the second-price auction. In a uniform-price auction, all of the winning bidders pay the price submitted by the highest non-winning bidder. Bidders will not typically bid their true value in a uniform-price auction with multiple units. In a Vickrey auction, the pricing rule is more complicated, but preserves the property that bidders will bid their true valuation. It is also possible to auction each identical item individually. Once each item has been priced, the winning bidder is entitled to buy the remaining goods at the same price. Items the winning bidder opts not to purchase are auctioned again. This system creates a tension between the desire to hold back on bidding since later items will almost certainly be cheaper, and the chance that by losing the first round of bidding all possibility of purchasing will be lost.

Bidders in the traditional Dutch auction and sealed first-price auction will tend to underbid what they believe the item is truly worth in hopes of getting the item for less, or in order to avoid the winner's curse (i.e., a tendency for the winning bid to exceed the intrinsic value of the item being auctioned). This behavior is known as bid shading. These two auctions are also theoretically equivalent, but in practice, Dutch auctions often produce less revenue than sealed first-price auctions.

Unlike conventional auctions (e.g., English auctions, Dutch auctions, sealed first-price auctions, and sealed second-price auctions) which have a single vendor (i.e., the auctioneer) and multiple vendees, double auctions have multiple vendors and multiple vendees. In certain embodiments, each of these vendees and vendors submit a single bid for a single unit. In other embodiments, each of these vendees and vendors submit multiple bids for a single unit or for multiple units. Also, in certain embodiments, bids arrive and expire at different times. Thus, decisions to buy or sell must be made without knowing what bids will arrive in the future.

In one embodiment, forum participants include, but are not limited to, trading platform operators and issuers, vendors, and vendees of non-marketable securities. As used herein, the term “trading platform operator” means a company, agency, or organization that initiates, establishes, organizes, or otherwise puts into operation the forum and pricing mechanism. As used herein, the term “issuer” means a company, agency, or organization identified on the security or that is otherwise primarily responsible for the production, offering, or distribution of a security. As used herein, the term “vendor” means one who offers to sell a security and the term “vendee” means one who offers to buy a security. In certain embodiments, a single entity can serve both as vendor and vendee. For example, in certain embodiments utilizing a double auction-type pricing mechanism, a person may make offers to buy some amount of a particular security at a first price and sell some amount of that security at a second price. The first and second prices may be the same or different.

Preferably, the present invention is practiced without a human broker, that is, transactions are conducted directly between the vendor of a security and a vendee of a security without the use of a human intermediary agent for either party. It is contemplated, however, that in certain embodiments the present invention may be practiced with intelligent software agents acting as delegates of their human masters.

The number of vendors and vendees can be a few as one vendor and one vendee. However, the accuracy of the valuation of the present method is influenced, at least in part, upon the number of participants and the extent of competition between vendors, between vendees, and between a vendor and vendee. Thus, the present method is preferably practiced with multiple participant vendors and vendees which are in competition to buy and/or sell a particular security or related securities. In general, if the ratio of forum vendees to vendors increases with respect to the true market ratio of vendees to vendors, the resulting demand may upwardly skew the estimated value of the security to a higher price. Similarly, if the ratio of forum vendees to vendors decreases with respect to the true market ratio of vendees to vendors, then the resulting supply may downwardly skew the estimated value of the security to a lower price.

In certain embodiments, in consultation with and at the direction of the securities issuer, the trading platform operator will establish forum rules defining who can access the forum as a vendor and/or vendee and what types of securities can be traded. For example, a trading platform operator may limit access to a forum only to vendors and/or vendees who are employees of a particular company or who are affiliated with a particular organization. In addition, the trading platform operator may limit the type of non-marketable securities that can be traded on a forum to certain classes of employee stock options. Thus, in one embodiment, a forum's transactions may be limited to trading employee stock options between individual vendors and vendees who are both employees of the same company. In certain embodiments, the trading platform operator is the issuer of the security.

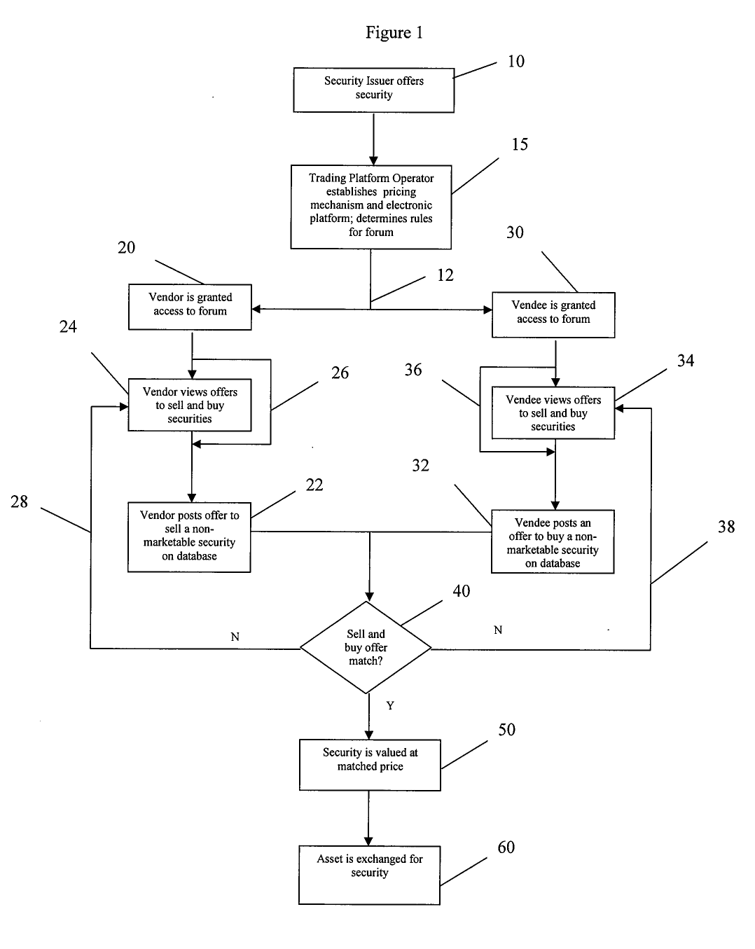

Turning now to FIG. 1, a flow chart of an embodiment of the invention is shown wherein a forum is provided to value one or more non-marketable securities. According to this embodiment, the overall process for valuing a non-marketable security begins with a security issuer offering a non-marketable security 10 and a trading platform operator 15 establishing a pricing mechanism to define the organization, information exchange process, trading procedure of the forum for the security 10. For embodiments where the non-marketable security is an employee stock option, the issuer is the company issuing the option. The mechanism is communicated to potential market participants, particularly to potential vendees and vendors, before the opening of the market so that every participant knows how the market will operate in advance 12.

Once the pricing mechanism is established, other design aspects, such as communication protocol, integration and transaction support, security issues, etc., are established by the trading platform operator. The communication protocol should be designed to facilitate the information exchange process, transaction support should obey the specific market clearance rules, such as rules for determining quantities and matchings for all trades, and security measures should be deployed to protect the specific sensitive information. Other rules established by the trading platform operator can include rules as to whom may access the forum, time limits for trading a security, whether a real or virtual asset is exchanged for the security, what type (i.e., class) of employee may trade, periods of “blackout” time when no trading or only limited trading may occur, limitations on trading within certain predefined days of the expiration of the instrument, and the like.

Vendors 20 may gain access to the forum as per the rules established by the trading platform operator 15. After gaining access, a vendor may post a sell offer for a security at an initial sell price 22 in accordance with the forum rules established by the trading platform operator. The term “initial sell price” as used herein is the price at which a vendor initially offers to sell a security. The initial sell price may or may not be the minimum price that a vendor is willing to accept for the security or the actual price for which the security is sold to a vendee. For example, if the forum comprises an English auction, the vendor may post an offer to sell one or more shares of an employee stock option at a relatively low price with, optionally, a reserve price. If the forum comprises a Dutch auction, the vendor may alternatively post an offer at a relatively high offering price with, optionally, a reserve price. If the forum comprises a double auction, the vendor may post multiple offers to sell one or more shares of a security, such as an employee stock option, and also multiple offers to buy the same security. In one embodiment, the initial sell price and any other vendor generated prices such as a reserve price, are determined exclusively by, and at the sole discretion of, the vendor, provided that any such prices are established in accordance with the forum rules.

The posting of a sell offer can be made before, after, or contemporaneously with the posting of a buy offer. Thus, a vendor can post a sell offer in the forum regardless of whether any buy offer exists at the time of the posting.

According to the embodiment described in FIG. 1, the vendor's ability to view the postings of other vendors and vendees 24, 26 is optional and is dependent upon the rules established by the trading platform operator 15. For example, if the market mechanism established by the vendor is a sealed first-price auction, buy offers posted by vendees may not be revealed in the forum to buying or selling participants during the auction. If the market mechanism permits the vendor to access information regarding buy and/or sell offers posted by other participants, the vendor can access this information prior to posting a sell offer 22.

Vendees 30 may gain access to the forum as per the rules established by the trading platform operator 15. After gaining access, a vendee may post a buy offer for a security at an initial buy price 32 in accordance with the forum rules established by the trading platform operator. The term “initial buy price” as used herein is the price at which the vendee initially offers to buy a security. The initial buy price may or may not be the maximum price that a vendor is willing to pay for the security or the actual price for which the security is bought from a vendor. In accordance with the pricing mechanism and related rules established by the issuer, the vendee may offer one or multiple buy offers, optionally at different prices. Multiple buy offers by a vendee may be made concurrently or sequentially with respect to other offers by the vendee or by other vendees. Additionally, if the forum comprises a double auction, the vendee may post not only multiple offers to buy one or more shares of a security, such as an employee stock option, but also multiple offers to sell the same security. In one embodiment, the initial buy price and any other vendee generated prices are determined exclusively by, and at the sole discretion of, the vendee provided that any such prices are established in accordance with the forum rules. The trading platform operator may allow the trading of similar securities, and/or specify the amounts of each security to be offered, sold, and/or traded.

The posting of a buy offer can be made before, after, or contemporaneously with the posting of a sell offer. Thus, a vendee can post a buy offer in the forum regardless of whether any sell offer exists at the time of the posting.

After at least one sell offer and at least one buy offer has been posted to the forum, a determination is made as to whether the sell and buy offers constitute a match as defined by the pricing mechanism and rules established by the trading platform operator. For example, if the pricing mechanism is an English auction, a match is made between the sell offer and the highest buy offer, provided that conditions of the auction are met (e.g., the time period for the auction has ended, the vendor's reserve price, if any, has been met, and the like). If the pricing mechanism is an exchange, a match between a sell offer and a buy offer is made contemporaneously with their respective postings. Other types of matching criteria may also be practiced with this invention, including, for example, grant dates, vesting, or exercise price. Such criteria are known to those skilled in the art.

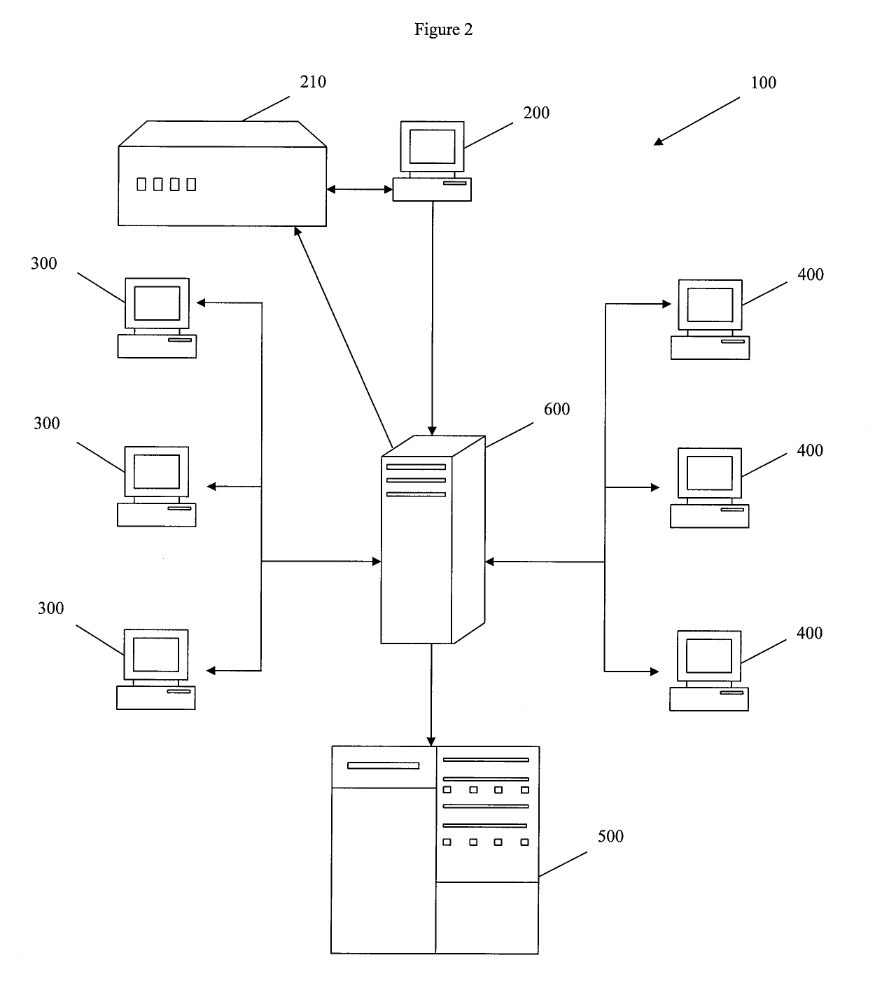

FIG. 2 shows an embodiment of an electronic forum according to the present invention having an electronic platform including a computer-based system for receiving, sending, storing, and processing information, particularly information in the form of electromagnetic data. Although a computer-based system is shown in FIG. 2, it is understood that, according to the present invention, an electronic forum includes any electronic system used to convey information pertaining to an offer to sell and/or an offer to buy a non-marketable security.

The present invention may be practiced on any type of electronic platform, including but not limited to personal computers (PCs), mainframe computers, personal digital assistants (PDAs), host/server computer systems, LAN systems, WAN systems, cellular telephones, telephones, and the like. Those skilled in the art will recognize that the choice of electronic platform will be dependent upon a number of factors including, but not limited to, capacity (e.g., the number of users and the frequency of transactions), security (e.g. prevention of unauthorized access to the platform), and sophistication (e.g., the complexity of the software used facilitate trading). Further, it is understood that the various devices, modules, mechanisms and systems described herein may be realized in hardware, software, or combinations of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific-use computer, containing specialized hardware for carrying out one or more of the functional tasks of the invention could be utilized. The present invention can also be embedded in a computer program product, which comprises all the features enabling the implementation of the methods and functions described herein, and which—when loaded in a compatible computer system—is able to carry out these methods and functions. The terms “computer program”, “software program”, “program”, “program product”, or “software”, in the present context include any expression, in any language, code or notation, of a set of instructions intended to cause a system having an information processing capability to perform a particular function either directly or after the following: (a) conversion to another language, code or notation; and/or (b) reproduction in a different material form.

In one embodiment, the electronic platform includes a computer system having a memory, a CPU, an input/output device (I/O), a bus, and nonvolatile data storage such as a nonvolatile database. Memory may comprise any known or hereafter developed type of data storage system and/or transmission media, including magnetic media, optical media, random access memory (RAM), read only memory (ROM), a data object, and the like. Memory may reside at a single physical location comprising one or more types of data storage, or be distributed across a plurality of physical systems. Each respective CPU may likewise comprise a single processing unit, or a plurality of processing units distributed across one or more locations, e.g., on a client and server. Each respective I/O may comprise any known or hereafter developed type of input/output device including a network system, modem, keyboard, mouse, voice recognition system, video monitor, printer, disc drives, etc. Additional components, such as cache memory, communication systems, system software, etc., may also be incorporated into the computer system. Peripheral components may further include a transmission system for data transfers between, for example, a participant and the database or directly between two or more participants.

The computer system may include one or more central computers, i.e., servers. A server computer typically comprises an advanced mid-range multiprocessor-based server, such as the Ultra II from Sun Microsystems or the RS6000 from IBM, utilizing standard operating systems. In addition, the computer system includes standard operating software which is designed to perform computations and to drive the operation of the particular hardware and which is compatible with other system components, and I/O controllers.

The computer system can further involve the use of a programmable software product that is stored in system's memory. Such a product may be written in any applicable computer language, including but not limited to, any version of C#, Java, Ruby, Python, or the like.

As shown in FIG. 2, the electronic platform 100 is a server-based computer system having a host server 600. In one embodiment, software used to support the pricing mechanism is loaded onto the host 600. The host 600 is connected to multiple terminal systems for vendors 300, multiple terminal systems for vendees 400, and a terminal system for a trading platform operator 200. The terminal systems in FIG. 2 can be any type of electronic apparatus capable of transmitting and receiving information from a forum participant to the host 600. Examples of such apparatuses include, but are not limited to, PCs, PDAs, cellular telephones, telephones, and the like. In one embodiment, the terminal system transmits and receives digital data, such as by a transmission protocol or an internet protocol. In another embodiment, the terminal system transmits and receives voice information. For embodiments in which voice data is transmitted from a terminal system, the server can be equipped with hardware and/or software to convert between voice data and digital data.

The host 600 may also be connected to an electronic banking system 500 and to a management system utilized to manage the security being traded 210. According to the present invention, the term “electronic banking system” is meant to include a real or virtual establishment in which funds are kept for savings or commercial purposes, or are invested, used in making loans, or otherwise exchanged. Examples of real electronic banking systems include, but are not limited to, Internet-based systems of commercial banks, Internet-based systems of savings and loans, PayPal®, electronic payroll systems, and the like. In addition to real establishments, the present invention can utilize virtual electronic banking systems wherein virtual assets are traded for securities. Trading in virtual assets instead of real assets is especially beneficial for embodiments that estimate the value of an asset in conjunction with a mathematical method of decision-making in which a competitive situation is analyzed to determine the optimal course of action for an interested party (i.e. game theory). The use of virtual assets can also be advantageous to avoid potential regulatory restrictions, such as securities regulations and taxes. In another embodiment, the present invention can utilize virtual electronic banking systems wherein virtual assets are traded for virtual securities. In such embodiments, trading activity may be associated with, or used in connection with, simulating the behavior of real markets or in providing such functionality within the context of a massively multiplayer online role-playing game.

According to one embodiment, the host 600 is utilized to match sell offers and buy offers. When a match is confirmed, the host 600 sends instructions to the electronic banking system 500 to transfer funds from a vendee's account to a vendor's account. The host 600 also sends instructions to the management system 210 to transfer ownership of the securities being traded from the vendor to the vendee. The instructions sent from the host 600 to banking system 500 and/or management system 210 can be performed automatically or can be performed at the discretion of the vendor and/or vendee.

What is claimed is:

1. A method for establishing a value for a non-marketable security, comprising the step of providing an electronic forum for trading the security wherein said forum is adapted to receive at least one sell offer for the security and at least one buy offer for the security, to match a sell offer with a buy offer, and to establish a value of the security from the match.

2. The method of claim 1 wherein the forum is further adapted to exchange an asset for the security.

3. The method of claim 2 wherein the asset is a real asset.

4. The method of claim 2 wherein the asset is a virtual asset.

5. The method of claim 1 wherein the forum comprises a pricing mechanism.

6. The method of claim 5 wherein the pricing mechanism is selected from the group consisting of exchanges, open-bid ascending-price auctions, open-bid descending-price auctions, sealed-bid first-price auctions, sealed-bid second-price auctions, double auctions, and combinations of two of more of these.

7. The method of claim 1 wherein the forum comprises participants selected from the group consisting of trading platform operators, security issuers, vendors, vendees, and combinations of two or more of these.

8. The method of claim 7 wherein said forum comprises a plurality of vendees.

9. The method of claim 7 wherein said forum comprises a plurality of vendors.

10. The method of claim 7 wherein the security is traded directly between a vendor and a vendee.

11. The method of claim 7 wherein the trading platform operator is the security issuer.

12. The method of claim 12 wherein the security issuer selects the pricing mechanism.

13. The method of claim 7 wherein the at least one sell offer and the at least one buy offer are accessible by the vendors and the vendees.

14. The method of claim 1 wherein the security is an employee stock option.

15. The method of claim 14 wherein the vendors and the vendees are employees or members of a single organization.

16. The method of claim 1 wherein the electronic forum comprises an electronic platform adapted to receive, send, store, and process information related to the at least one sell offer and the at least one buy offer.

17. The method of claim 16, wherein the electronic platform is selected from the group consisting of personal computers, personal digital assistants, mainframe computers, host/server computer systems, LAN systems, WAN systems, and cellular telephones.

18. The method of claim 17 wherein the electronic platform is adapted to communicate with an electronic banking system.

19. The method of claim 18 wherein the electronic banking system is a virtual banking system.

20. The method of claim 17 further comprising a database of sell offers and buy offers available on the forum.

21. A method for establishing a value for a non-marketable security, comprising the step of posting a sell offer or a buy offer for the security onto an electronic forum, wherein the forum is adapted to receive at least one sell offer and at least one buy offer, to match a sell offer to a buy offer, and to establish a value of the security from the match.

22. A method for establishing a value for a non-marketable security, comprising the step of exchanging an asset having a value equivalent to a forum-derived value for the security, wherein the forum-derived value is determined by matching a sell offer with a buy offer in an electronic forum for trading non-marketable securities, and wherein the forum is adapted to receive at least one sell offer and at least one buy offer for a the security, to match a sell offer with a buy offer, and to establish a value of the security from the match.

23. The method of claim 22 wherein the asset is a real asset.

24. The method of claim 22 wherein the asset is a virtual asset.

25. An electronic trading platform for valuing a non-marketable security comprising:
a. an electronic database for maintaining at least one sell offer for the security and at least one buy offer for the security;
b. a system for receiving a vendor's sell offer;
c. a system for receiving a vendee's buy offer;
d. a system for transferring sell offers and buy offers from the database to vendors and vendees;
e. a system for matching sell offers and buys offers; and
f. a system for establishing a value of the security based upon at least one match between sell offer and buy offer.

26. The electronic trading platform of claim 26 further comprising a system for exchanging an asset for the security, wherein the asset has a value equivalent to the established value of the security.

27. The electronic trading platform of claim 27 wherein the asset is a real asset.

28. The electronic trading platform of claim 27 wherein the asset is a virtual asset.

29. The electronic trading platform of claim 26 wherein the security is an employee stock option.
